(19) United States
(12) Patent Application Publication
(10) Pub. No.: US 2008/0126652 A1
(43) Pub. Date: May 29, 2008

(54) Managing Interrupts in a Partitioned Platform

(75) Inventors: Balaji Vembu, Folsom, CA (US); Jose A. Vargas, Rescue, CA (US); Jasmin Ajanovic, Portland, OR (US); Ulhas Warrier, Beaverton, OR (US); David Koufaty, Portland, OR (US)

Correspondence Address: GROSSMAN, TUCKER, PERREAULT & PFLEGER, PLLC;C/O PORTFOLIO IP, P. O. BOX 52050, MINNEAPOLIS, MN, 55402, US

(73) Assignee: INTEL CORPORATION, Santa Clara, CA (US)

(21) Appl. No.: 11/535,769

(22) Filed: Sep. 27, 2006

(51) Int. Cl. G06F 13/24

(52) U.S. Cl. 710/268

(57) ABSTRACT

A method according to one embodiment may include partitioning a multi-core processor into a first partition and a second partition, the first partition including a first processor core and a first interrupt controller configured to store a first partition identifier, the second partition including a second processor core and a second interrupt controller configured to store a second partition identifier. The method may also include receiving, by the first interrupt controller and the second interrupt controller, at least one interrupt that includes a partition identifier. The method may also include comparing, by the first interrupt controller, the partition identifier included with the interrupt to the first partition identifier stored in the first interrupt controller.

### FIELD

The present disclosure relates to managing interrupts in a partitioned platform.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 depicts one exemplary system embodiment consistent with the present disclosure;

FIG. 2 depicts a flowchart of exemplary operations of a partition manager consistent with the present disclosure;

FIG. 3 depicts a flowchart of one method for handling inter-processor interrupts consistent with one embodiment of the present disclosure; and

FIG. 4 depicts a flowchart of one method for handling device interrupts consistent with one embodiment of the present disclosure.

Although the following Detailed Description will proceed with reference being made to illustrative embodiments, many alternatives, modifications, and variations thereof will be apparent to those skilled in the art.

### DETAILED DESCRIPTION

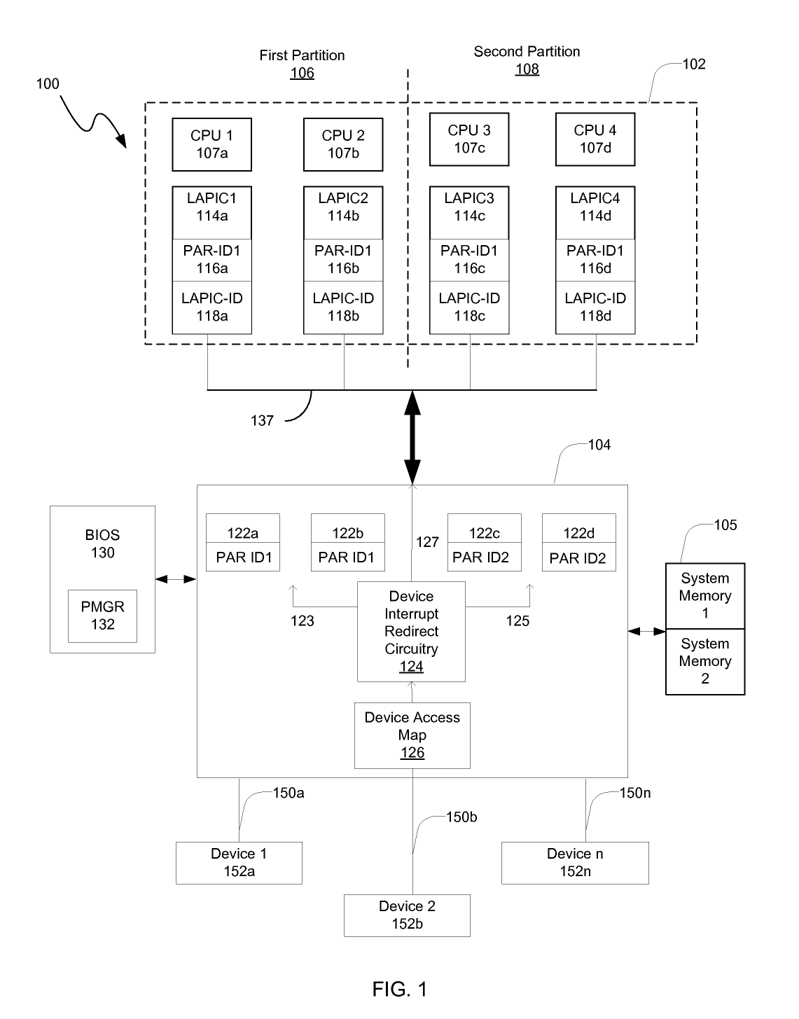

FIG. 1 depicts one exemplary system embodiment 100 consistent with the present disclosure. System 100 may comprise a partitioned platform and may include multi-core processor circuitry 102, chipset circuitry 104, system memory 105 and system BIOS (Built-in Operating System) 130. Multi-core processor 102 may include any variety of processors having a plurality of cores, for example, an Intel® Pentium® dual core processor commercially available from the Assignee of the subject application.

In one embodiment, multi-core processor 102 may include a plurality of processor cores, for example, CPU1 107a, CPU2 107b, CPU3 107c and CPU4 107d. Of course, additional or fewer processor cores may be used without departing from this embodiment. Multi-core processor 102 may be logically and/or physically divided into a plurality of partitions. For example, processor 102 may be divided into a first partition 106 that, in the example of FIG. 1, includes CPU1 and CPU2, and a second partition 108 that includes CPU3 and CPU4. Of course, additional partitions may be used without departing from this embodiment. Also, additional processors having one or more cores and assigned to additional partitions may be used without departing from this embodiment.

System memory 105 may comprise one or more of the following types of memories: semiconductor firmware memory, programmable memory, non-volatile memory, read only memory, electrically programmable memory, random access memory, flash memory (which may include, for example, NAND or NOR type memory structures), magnetic disk memory, and/or optical disk memory. Either additionally or alternatively, memory 105 may comprise other and/or later-developed types of computer-readable memory. Machine-readable firmware program instructions may be stored in memory 105. These instructions may be accessed and executed by the first partition 106 and/or second partition 108 of host processor 102. When executed by host processor 102, these instructions may result in host processor 102 performing the operations described herein. In some embodiments, memory 105 may be logically and/or physically partitioned into system memory 1 and system memory 2. System memory 1 may be capable of storing commands, instructions, and/or data for operation of the main partition 106, and system memory 2 may be capable of storing commands, instructions, and/or data for operation of the second partition 108.

Each core of the multi-core processor 102 may include an interrupt controller configured to generate and receive interrupts. In one embodiment, each interrupt controller may include a local advanced programmable interrupt controller (LAPIC), for example, LAPIC1 114a, LAPIC2 114b, LAPIC3 114c, and LAPIC4 114d. In this embodiment, each respective LAPIC 114a, 114b, 114c and 114d may be configured to manage the interrupts of a respective core, 107a, 107b, 107c and 107d, respectively. Thus, for example, LAPIC1 114a may be configured to manage the interrupts of core CPU1 107a, LAPIC2 114b may be configured to manage the interrupts routed to CPU2 107b, etc. Each LAPIC may be configured to communicate with other LAPICs, via bus 137. Thus, for example, at least one LAPIC may be configured to generate a directed interrupt or broadcast at least one inter-processor interrupt (IPI) to at least one other LAPIC, and receive an IPI from at least one other LAPIC. Additionally, each LAPIC may be configured to receive one or more device interrupts from one or more devices (e.g., 152a, 152b, . . . , 152n) coupled to chipset 104, as will be described below.

Each partition (e.g 106, 108, etc) may be assigned a unique partition-ID. Partition identification (PAR-ID) information may be associated with each core, and the PAR-ID may be stored in respective partition identification fields 116a, 116b, 116c and 116d of each respective LAPIC. The PAR-ID field may include an identifier unique for each partition. Thus, for example, the first partition 106 may be identified as partition 1 (PAR-ID1) and the second partition 108 may be identified as partition 2 (PAR-ID2). In that case, since cores 107a and 107b may be assigned to partition 1, PAR-ID 116a and 116b may have an ID of 1 (PAR-ID1), and since cores 107c and 107d may be assigned to partition 2 108, PAR-ID 116c and 116d may have an ID of 2 (PAR-ID2). Each PAR-ID may be represented by, for example, an eight bit binary number within the respective PAR-ID field. In addition, each LAPIC may include a LAPIC-ID field 118a, 118b, 118c and 118d. The LAPIC-ID field may include a LAPIC identifier to permit, for example, each LAPIC to identify itself among the plurality of LAPICs of the processor 102. However, the LAPIC_ID may not be unique across partitions. Thus, for example, LAPIC-ID field 118a and LAPIC-ID field 118c may both be assigned a LAPIC-ID of 1.

As stated, each LAPIC may be configured to generate one or more IPIs. In this embodiment, each LAPIC may be configured to append the PAR-ID information (as stored in the PAR-ID field) to an IPI generated by the LAPIC. Each LAPIC may be further configured to compare the PAR-ID stored in the PAR-ID field of the LAPIC with the PAR-ID of an incoming interrupt. If the two match, the LAPIC may be configured to pass the interrupt to the associated core, and if the two PAR-IDs do not match, the interrupt may be ignored. For example, LAPIC 114a may be configured append the PAR-ID stored in PAR-ID field 116a to an IPI and to broadcast an IPI to all of the cores, via bus 128. LAPIC 114b may be configured to receive the IPI generated by LAPIC 114a and compare the PAR-ID appended to the IPI with the PAR-ID stored in PAR-ID field 116b. If the two match (as may be the case in the example of FIG. 1) LAPIC 114b may pass the interrupt to core 107b. Likewise, LAPIC 114d may be configured to receive the IPI generated by LAPIC 114a and compare the PAR-ID appended to the IPI with the PAR-ID stored in PAR-ID field 116d. If the two do not match (as may be the case in the example of FIG. 1), then LAPIC 114d may ignore the interrupt. By providing a unique partition ID for each LAPIC may prevent, for example, an interrupt from being claimed by a core in another partition.

Chipset 104 may be coupled to one or more devices 152a, 152b, . . . , 152n via respective buses 150a, 150b, . . . , 150n. Chipset 104 may be configured to control the routing of interrupts, generated by one or more devices, to one or more processor cores (e.g., CPU 1, CPU2, CPU3 and CPU4). Device 152a, 152b, . . . , 152n may be any type of peripheral device, for example, host bus adapter (HBA), network controller, RAID controller, etc. Thus, the term “device” as used herein is to be construed broadly as any component and/or system that can generate an interrupt to processor 102. Chipset 104 may be configured as an I/O controller hub, which may include “North Bridge” chipset features (for example, memory and processor I/O control) and/or “South Bridge” chipset features (for example, peripheral device and bus I/O control). Of course, chipset 104 may include additional features, for example, video I/O control, audio I/O control and/or other chipset functionality. Chipset 104 may include integrated circuit (IC) chips, such as those selected from integrated circuit chipsets commercially available from the assignee of the subject application (e.g., graphics memory and I/O controller hub chipsets), although other integrated circuit chips may also, or alternatively be used.

Buses 150a, 150b, . . . , 150n may each comply or be compatible with Peripheral Component Interconnect (PCI) Express™ Base Specification Revision 1.0, published Jul. 22, 2002 available from the PCI Special Interest Group, Portland, Oreg., U.S.A.). Chipset 104 may be coupled to host processor 102 via bus 137. Bus 137 may be comprised of a variety of bus architectures, such as, for example, a front side bus (FSB) architecture and/or a configurable system interconnect (CSI) bus and/or other internal bus. Chipset 104 may also control communication between processor 102, one or more devices 152a, 152b, . . . , 150n and system memory 105.

It should be understood that devices 152a, 152b, . . . , 152n need not be external to chipset 104. In other embodiments, one or more devices, as defined herein, may be integrated in chipset 104 and/or integrated in other components of the system of FIG. 1. Thus, the phrase “coupled to the chipset”, as used herein with reference to one or more devices, may be defined as external to the chipset 104 (as depicted in FIG. 1) or integrated with the chipset 104.

Chipset 104 may include a plurality of task-priority registers (TPR) 122a, 122b, 122c and 122d. Each TPR may include a data field to store partition ID (PAR-ID) information, to permit each TPR to be assigned to a partition. For example, TPR 122a and 122b may be assigned to the first partition 106, and thus, respective partition-ID data fields of TPR 122a and 122b may each include a PAR-ID1 identifier. Similarly, TPR 122c and 122d may be assigned to the second partition 108, and thus, respective partition-ID data fields of TPR 122c and 122d may each include a PAR-ID2 identifier. Each TPR may be configured to perform arbitration of device interrupts based on, for example, availability of one or more cores within a partition and/or other arbitration techniques such as priority and/or round robin arbitration. Each TPR may be configured to permit the chipset 104 to route an interrupt to a core that is appropriate, for example, a core that is executing the lowest priority task or the core that is next in line to service interrupts (e.g., round robin scheme). Thus, each TPR may be configured to designate a priority state of the core associated with the TPR. The priority states designated by each TPR may be changed to reflect the level of priority of the tasks being performed by the respective core of processor 102. Thus, for example, Each TPR 116a, 116b, 116c, 116d may include additional identification data, for example, physical identifiers and/or logical identifiers.

Chipset 104 may also include a device access map (DAM) 126. The DAM 126 may include an assignment map (e.g., a look-up table) to assign one or more of the plurality of devices 152a, 152b, . . . , 152n to one or more partitions 106 and/or 108. Each device 152a, 152b, . . . , 152n may be identified by, for example, a requester ID using a PCI Bus/Device/Function (BDF) number, which may be assigned by software (e.g., PCI configuration software). The requester ID may uniquely identify the hardware/device that initiated a request. For example, following the example of FIG. 1 having two partitions 106 and 108, assume four devices are coupled to chipset 104 having BDF numbers D1, D2, D3 and D4, respectively. If partition 106 having PAR-ID 1 is allocated D1, D2 and D3 and partition 108 having PAR-ID 2 is allocated D4, DAM 126 may include map entries that associate devices to processor cores in the following arrangement:

DAM (106): (Partition ID 1; D1: BDF, D2: BDF, D3: BDF)

DAM (108): (Partition ID 2; D4: BDF)

Thus, when a device interrupt is received from one or more devices 152a, 152b, . . . , 152n, the DAM 126 may be used to identify the appropriate partition for the interrupt. Thus, for example, if an interrupt is received from a device having a BFD number of D4, DAM 126 may identify that this interrupt should be serviced by partition 2 (108).

Chipset 104 may also include device interrupt redirect circuitry 124. Circuitry 124 may be configured to append PAR-ID information to an interrupt based on, for example, the appropriate partition allocated to the device, as identified by the DAM 126. Thus, fore example, if device 152a is allocated to the first partition 106, circuitry 124 may be configured to append a PAR-ID of 1 (PAR-ID1) to the interrupts generated by device 152a. Depending on the availability of core within a partition 106 or 108 to service an interrupt, device interrupt redirect circuitry 124 may be configured to forward an interrupt directly to the appropriate partition (path 127) or redirect the interrupt to a core chosen by arbitration within the TPR of the partition identified by the device interrupt. Alternatively, if a device interrupt does not need to be redirected (as may the case if the device interrupt includes, or example, core ID information and/or information that includes a request to redirect the device interrupt) then the interrupt may be forwarded, without redirection, directly to the appropriate core of the appropriate partition, via path 127.

Once a device interrupt and PAR-ID information is forwarded to a core of a partition, either directly from circuitry 124 or via one or more TPRs 112a, 122b,122c and/or 122d, the LAPIC of associated with the core receiving the device interrupt may be configured to compare the PAR-ID appended to the device interrupt with the PAR-ID assigned to the core (e.g., 116a, 116b, 116c and/or 116d). This may enable, for example, confirmation that the chipset 104 forwarded the device interrupt to the appropriate partition.

System BIOS 130 may be configured to initialize operating parameters and establish general system settings, as is well known in the art. In this embodiment, the system BIOS 130 may include a partition manager (PMGR) 132 configured to set up the partitioned environment of the system 100. For example, partition manager 132 may be configured to allocate resources among the partitions (e.g., partition 106 and partition 108). In addition, PMGR 132 may be configured to program the chipset 104 to enforce partition boundaries, as will be described below. PMGR 132 may be embodied as software and/or firmware, and may be concealed from other software executed by the partitions 106, 108 and/or BIOS 130 and/or other software running on system 100.

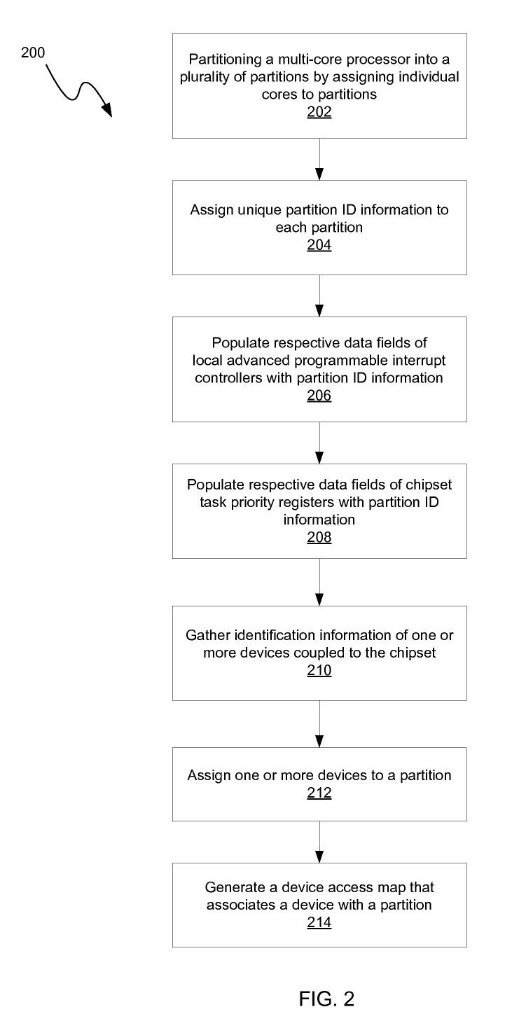

FIG. 2 depicts a flowchart 200 of exemplary operations of the partition manager consistent with the present disclosure. Operations may include configuring a multi-core processor into a plurality of partitions by assigning individual cores to partitions 202. Operations may further include assigning unique partition ID (PAR-ID) information to each partition 204. Operations of the partition manager may further include populating respective data fields of local advanced programmable interrupt controllers with the partition ID information 206. Operations may further include populating respective data fields of chipset task priority registers with the partition ID information 208. This operation may assign a task priority register to a specific partition. Additional operations may include gathering device identification information of one or more devices coupled to the chipset 210. Operations may also include assigning one or more devices coupled to the chipset to a partition 212. Operations of the partition manager may also include generating a device access map that associates a device with a partition 214.

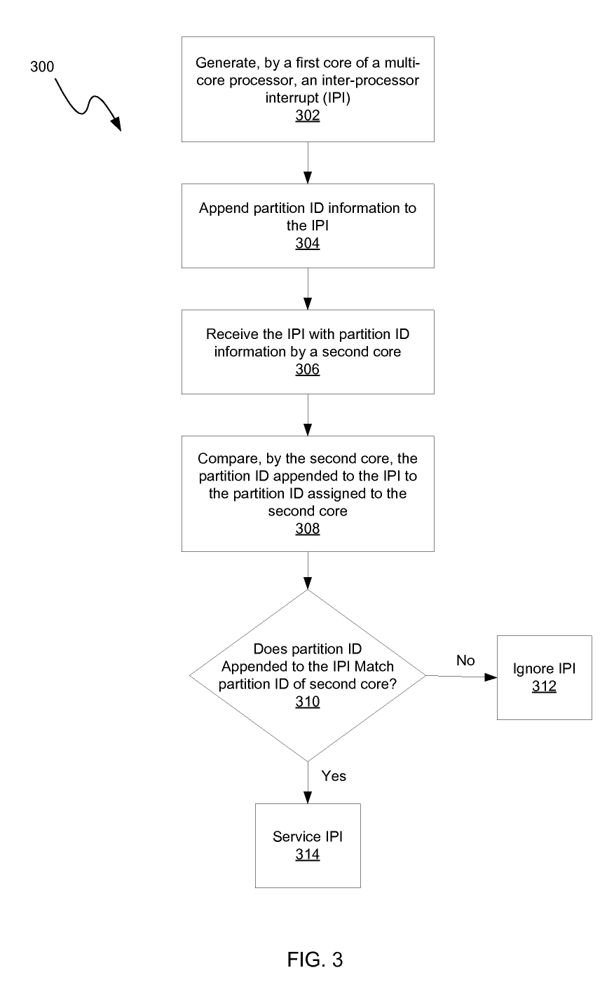

FIG. 3 depicts a flowchart 300 of one method for managing inter-processor interrupts consistent with one embodiment of the present disclosure. Operations of this embodiment may include generating, by a first core of a multi-core processor, an inter-processor interrupt (IPI) 302. Operations may further include appending partition ID information to the IPI 304. Operations may additionally include receiving the IPI with partition ID information by a second core 306. Operations may further include comparing, by the second core, the partition ID information appended to the IPI to the partition ID information assigned to the second core 308. Operations may additionally include determining if the partition ID appended to the IPI matches the partition ID of the second core 310. If a match does not exist, the second core may ignore the IPI 312. If a match exists, the second core may service the IPI 314.

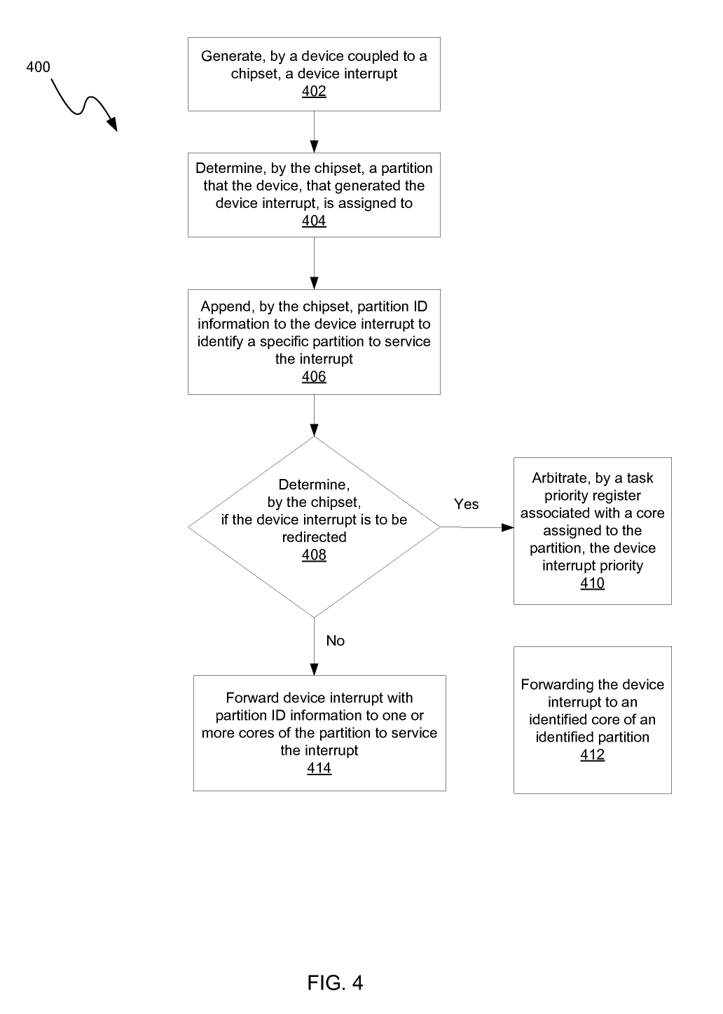

FIG. 4 depicts a flowchart 400 of one method for managing device interrupts consistent with one embodiment of the present disclosure. Operations of this embodiment may include generating, by a device coupled to a chipset, a device interrupt 402. Operations may also include determining, by the chipset, a partition assigned that the device, that generated the device interrupt is assigned to 404. Operations may further include appending, by the chipset, partition ID information to the device interrupt to identify a specific partition to service the device interrupt 406. Operations may additionally include determining, by the chipset, if the device interrupt is to be redirected 408. If the device interrupt is to be redirected (as may be indicated by the device interrupt itself), operations may also include arbitrating, by a task priority register associated with a core assigned to the partition, the priority of the device interrupt 410, and forwarding the device interrupt to an identified core of an identified partition 412, If the device interrupt is not redirected, the operations of this embodiment may further include forwarding the device interrupt with the partition ID information to one or more cores of the appropriate partition to service the interrupt 412.

Embodiments of the methods of FIGS. 2-4 described above may be implemented in a computer program that may be stored on a storage medium having instructions to program a system (e.g., a machine) to perform the operations. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

“Circuitry”, as used in any embodiment herein, may comprise, for example, singly or in any combination, hardwired circuitry, programmable circuitry, state machine circuitry, and/or firmware that stores instructions executed by programmable circuitry. Any of the operations, methods and/or operative components described in any embodiment herein may be implemented in software, firmware, hardwired circuitry and/or any combination thereof. In addition, processor 102, chipset 104, system memory 105 and BIOS 130 may collectively or individual be implemented in one or more integrated circuits. “Integrated circuit”, as used in any embodiment herein, may mean a semiconductor device and/or microelectronic device, such as, for example, a semiconductor integrated circuit chip.

In at least one embodiment, the first and second partitions may be configured to execute one or more operating systems. For example, the partitions 106 and/or 108 may be capable of executing a main operating system, which may include, for example, a general operating system such as Microsoft® Windows® XP, commercially available from Microsoft Corporation, and/or other “shrink-wrap” operating system such as Linux, etc. Alternatively or additionally, partitions 106 and/or 108 may be capable of executing an embedded operating system (OS).

The embedded OS may include, for example, a Berkely Software Distribution (BSD) operating system. For example, the embedded OS may comply or be compatible with OpenBSD Version 3.9, Released May 1, 2006 by the OpenBSD Organization and/or earlier and/or later versions of the OpenBSD operating system. Alternatively or additionally, the embedded OS may comply or be compatible with NetBSD® Release 3.0.1, Released Aug. 17, 2006 by the NetBSD® Foundation, Inc. and/or earlier and/or later versions of the NetBSD® operating system. Alternatively or additionally, the embedded OS may comply or be compatible with FreeBSD Release 6.1, Released May 8, 2006 by the FreeBSD Project and/or earlier and/or later versions of the FreeBSD operating system. Alternatively or additionally, OS 106 may also comply or be compatible with Linux Operating System, Version 2.6, Released Jun. 18, 2006 by the Linux Organization and/or earlier and/or later versions of the Linux operating system. Alternatively or additionally, the embedded OS may comply or be compatible with Microsoft® Windows® CE (WinCE) operating system Version 5.0, commercially available from Microsoft Corporation, and/or earlier and/or later versions of the WinCE operating system. Alternatively or additionally, the embedded OS may comply or be compatible with VxWorks operating system Version 1.0, commercially available from Wind River Corporation, and/or earlier and/or later versions of the VxWorks operating system operating system. Alternatively or additionally, the embedded OS may comply or be compatible with ThreadX® operating system Version 1.0, commercially available from Express Logic, Inc., and/or earlier and/or later versions of the ThreadX® operating system operating system. Alternatively or additionally, the embedded OS may comply or be compatible with RTLinux® operating system Version 3.0, commercially available from FSM Labs, Inc., and/or earlier and/or later versions of the RTLinux® operating system. Of course, the embedded OS may comply or be compatible with different operating systems (such as, for example, alternative run time and/or real time operating systems) without departing from this embodiment.

Further, the first and/or second partitions 106/108 may be configured to operate without an operating system, using, for example, Extensible Firmware Interface (EFI) that complies or is compatible with the Extensible Firmware Interface Specification, Version 2.0, Released Jan. 31, 2006 by the Unified EFI (UEFI) Forum and/or earlier and/or later versions of the EFI specification. Of course, the foregoing are only examples of operating systems that may be executed by the first and second partitions and the embodiments of the present disclosure are not limited to any specific operating system

Thus, a method according to one embodiment may include partitioning a multi-core processor into a first partition and a second partition, the first partition including a first processor core and a first interrupt controller configured to store a first partition identifier, the second partition including a second processor core and a second interrupt controller configured to store a second partition identifier. The method may also include receiving, by the first interrupt controller and the second interrupt controller, at least one interrupt that includes a partition identifier. The method may also include comparing, by the first interrupt controller, the partition identifier included with the interrupt to the first partition identifier stored in the first interrupt controller.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An apparatus, comprising:
multi-core processor circuitry comprising a first partition and a second partition, said first partition comprising a first processor core and a first interrupt controller configured to store a first partition identifier, said second partition comprising a second processor core and a second interrupt controller configured to store a second partition identifier, said first interrupt controller and said second interrupt controller are each configured to receive at least one interrupt that includes a partition identifier, said first interrupt controller is further configured to compare said partition identifier included with said interrupt to said first partition identifier stored in said first interrupt controller.

2. The apparatus of claim 1, wherein said interrupt is a device interrupt, said apparatus further comprising chipset circuitry configured to receive said device interrupt from a device coupled to the chipset circuitry, said chipset circuitry is further configured to associate said device to said first partition or said second partition and to determine the partition that the device interrupt is associated with, said chipset circuitry is further configured to append said first partition identifier or said second partition identifier to said device interrupt and forward said device interrupt and said first partition identifier or said second partition identifier to said first partition or said second partition, based on, at least in part, the partition identified by said first partition identifier or said second partition identifier.

3. The apparatus of claim 1, wherein:
if a match exists between said partition identifier included with said interrupt and said first partition identifier, said first processing core is configured to service said interrupt; if a match does not exist between said partition identifier included with said interrupt and said first partition identifier, said first interrupt controller is configured to ignore said interrupt.

4. The apparatus of claim 1, wherein:
said second interrupt controller is further configured to compare said partition identifier included with said interrupt to said second partition identifier stored in said second interrupt controller, and wherein if a match exists between said partition identifier included with said interrupt and said second partition identifier, said second processing core is configured to service said interrupt; if a match does not exist between said partition identifier included with said interrupt and said second partition identifier, said second interrupt controller is configured to ignore said interrupt.

5. The apparatus of claim 1, wherein said interrupt is an inter-processor interrupt (IPI), said second interrupt controller is configured to generate said IPI and append said second partition identifier to said IPI.

6. The apparatus of claim 1, further comprising a storage medium storing instructions that when executed by a machine result in the following operations:
partitioning said multi-core processor into said first and second partitions and assigning said first core to said first partition and said second core to said second partition;
assigning said first partition identifier and said second partition identifier, said first and second partition identifiers are each unique; and
populating said first interrupt controller with said first partition identifier and populating said second interrupt controller with said partition identifier.

7. The apparatus of claim 2, further comprising a storage medium storing instructions that when executed by a machine result in the following operations:
assigning task priority registers of said chipset circuitry to said first partition or said second partition;
populating said task priority registers assigned to said first partition with said first partition identifier and populating said task priority registers assigned to said second partition with said second partition identifier;
gathering device identification information for one or more devices coupled to the chipset circuitry; and
assigning one or more devices to a partition

8. A method, comprising:
partitioning a multi-core processor into a first partition and a second partition, said first partition comprising a first processor core and a first interrupt controller configured to store a first partition identifier, said second partition comprising a second processor core and a second interrupt controller configured to store a second partition identifier;
receiving, by said first interrupt controller and said second interrupt controller, at least one interrupt that includes a partition identifier; and
comparing, by said first interrupt controller said partition identifier included with said interrupt to said first partition identifier stored in said first interrupt controller.

9. The method of claim 8, wherein said interrupt is a device interrupt, said method further comprising;
receiving, by chipset circuitry said device interrupt from a device coupled to the chipset circuitry;
associating, by said chipset circuitry, said device to said first partition or said second partition;
determining, by said chipset circuitry, the partition that the device interrupt is associated with;
appending, by said chipset circuitry, said first partition identifier or said second partition identifier to said device interrupt; and
forwarding, by said chipset circuitry, said device interrupt and said first partition identifier or said second partition identifier to said first partition or said second partition, based on, at least in part, the partition identified by said first partition identifier or said second partition identifier.

10. The method of claim 8, wherein:
if a match exists between said partition identifier included with said interrupt and said first partition identifier, said method further comprising servicing said interrupt by said first processing core; and wherein if a match does not exist between said partition identifier included with said interrupt and said first partition identifier, said method further comprising ignoring said interrupt by said first interrupt controller.

11. The method of claim 8, further comprising:
comparing, by said second interrupt controller, said partition identifier included with said interrupt to said second partition identifier stored in said second interrupt controller; and wherein if a match exists between said partition identifier included with said interrupt and said second partition identifier, said method further comprising servicing said interrupt by said second processing core; and wherein if a match does not exist between said partition identifier included with said interrupt and said second partition identifier, said method further comprising ignoring said interrupt by said second interrupt controller.

12. The method of claim 8, wherein said interrupt is an inter-processor interrupt (IPI), said method further comprising generating, by said second interrupt controller said IPI and appending said second partition identifier to said IPI.

13. The method of claim 8, further comprising:
assigning said first partition identifier and said second partition identifier, said first and second partition identifiers are each unique; and
populating said first interrupt controller with said first partition identifier and populating said second interrupt controller with said partition identifier.

14. The method of claim 9, further comprising:
assigning task priority registers of said chipset circuitry to said first partition or said second partition;
populating said task priority registers assigned to said first partition with said first partition identifier and populating said task priority registers assigned to said second partition with said second partition identifier;
gathering device identification information for one or more devices coupled to the chipset circuitry; and
assigning one or more devices to a partition.

15. A system, comprising:
a multi-core processor comprising a first partition and a second partition, said first partition comprising a first processor core and a first interrupt controller configured to store a first partition identifier, said second partition comprising a second processor core and a second interrupt controller configured to store a second partition identifier, said first interrupt controller and said second interrupt controller are each configured to receive at least one interrupt that includes a partition identifier, said first interrupt controller is further configured to compare said partition identifier included with said interrupt to said first partition identifier stored in said first interrupt controller; and
a memory device configured to be partitioned into a first partition for storing commands and data associated with said first partition of said processor and a second partition for storing commands and data associated with said second partition of said processor.

16. The system of claim 15, wherein said interrupt is a device interrupt, said system further comprising chipset circuitry configured to receive said device interrupt from a device coupled to the chipset circuitry, said chipset circuitry is further configured to associate said device to said first partition or said second partition and to determine the partition that the device interrupt is associated with, said chipset circuitry is further configured to append said first partition identifier or said second partition identifier to said device interrupt and forward said device interrupt and said first partition identifier or said second partition identifier to said first partition or said second partition, based on, at least in part, the partition identified by said first partition identifier or said second partition identifier.

17. The system of claim 15, wherein:
if a match exists between said partition identifier included with said interrupt and said first partition identifier, said first processing core is configured to service said interrupt; if a match does not exist between said partition identifier included with said interrupt and said first partition identifier, said first interrupt controller is configured to ignore said interrupt.

18. The system of claim 15, wherein:
said second interrupt controller is further configured to compare said partition identifier included with said interrupt to said second partition identifier stored in said second interrupt controller, and wherein if a match exists between said partition identifier included with said interrupt and said second partition identifier, said second processing core is configured to service said interrupt; if a match does not exist between said partition identifier included with said interrupt and said second partition identifier, said second interrupt controller is configured to ignore said interrupt.

19. The system of claim 15, wherein said interrupt is an inter-processor interrupt (IPI), said second interrupt controller is configured to generate said IPI and append said second partition identifier to said IPI.

20. The system of claim 15, further comprising a storage medium storing instructions that when executed by a machine result in the following operations:
partitioning said multi-core processor into said first and second partitions and assigning said first core to said first partition and said second core to said second partition;
assigning said first partition identifier and said second partition identifier, said first and second partition identifiers are each unique; and
populating said first interrupt controller with said first partition identifier and populating said second interrupt controller with said partition identifier.

21. The system of claim 16, further comprising a storage medium storing instructions that when executed by a machine result in the following operations:
assigning task priority registers of said chipset circuitry to said first partition or said second partition;
populating said task priority registers assigned to said first partition with said first partition identifier and populating said task priority registers assigned to said second partition with said second partition identifier;
gathering device identification information for one or more devices coupled to the chipset circuitry; and
assigning one or more devices to a partition.

22. An article, comprising a storage medium storing instructions that when executed by a machine result in the following operations:
partitioning a multi-core processor into a first partition and a second partition, said first partition comprising a first processor core and a first interrupt controller configured to store a first partition identifier, said second partition comprising a second processor core and a second interrupt controller configured to store a second partition identifier;
receiving, by said first interrupt controller and said second interrupt controller, at least one interrupt that includes a partition identifier; and
comparing, by said first interrupt controller said partition identifier included with said interrupt to said first partition identifier stored in said first interrupt controller.

23. The article of claim 22, wherein said interrupt is a device interrupt, said operations further comprising;
receiving, by chipset circuitry said device interrupt from a device coupled to the chipset circuitry;
associating, by said chipset circuitry, said device to said first partition or said second partition;
determining, by said chipset circuitry, the partition that the device interrupt is associated with;
appending, by said chipset circuitry, said first partition identifier or said second partition identifier to said device interrupt; and
forwarding, by said chipset circuitry, said device interrupt and said first partition identifier or said second partition identifier to said first partition or said second partition, based on, at least in part, the partition identified by said first partition identifier or said second partition identifier.

24. The article of claim 22, wherein:
if a match exists between said partition identifier included with said interrupt and said first partition identifier, said operations further comprising servicing said interrupt by said first processing core; and wherein if a match does not exist between said partition identifier included with said interrupt and said first partition identifier, said operations further comprising ignoring said interrupt by said first interrupt controller.

25. The article of claim 22, said operations further comprising:
comparing, by said second interrupt controller, said partition identifier included with said interrupt to said second partition identifier stored in said second interrupt controller; and wherein if a match exists between said partition identifier included with said interrupt and said second partition identifier, said operations further comprising servicing said interrupt by said second processing core; and wherein if a match does not exist between said partition identifier included with said interrupt and said second partition identifier, said operations further comprising ignoring said interrupt by said second interrupt controller.

26. The article of claim 22, wherein said interrupt is an inter-processor interrupt (IPI), said operations further comprising generating, by said second interrupt controller said IPI and appending said second partition identifier to said IPI.

27. The article of claim 22, said operations further comprising:
assigning said first partition identifier and said second partition identifier, said first and second partition identifiers are each unique; and
populating said first interrupt controller with said first partition identifier and populating said second interrupt controller with said partition identifier.

28. The article of claim 23, said operations further comprising:
assigning task priority registers of said chipset circuitry to said first partition or said second partition;
populating said task priority registers assigned to said first partition with said first partition identifier and populating said task priority registers assigned to said second partition with said second partition identifier;
gathering device identification information for one or more devices coupled to the chipset circuitry; and
assigning one or more devices to a partition.
